(19) United States
(12) Patent Application Publication
(10) Pub. No.: US 2025/0112803 A1
(43) Pub. Date: Apr. 3, 2025

(54) METHOD FOR GENERATING SEQUENCE, AND COMMUNICATION DEVICE

(71) Applicant: GUANGDONG OPPO MOBILE TELECOMMUNICATIONS CORP., LTD., Dongguan (CN)

(72) Inventor: Jing XU, Dongguan (CN)

(21) Appl. No.: 18/980,725

(22) Filed: Dec. 13, 2024

Related U.S. Application Data
(63) Continuation of application No. PCT/CN2022/099268, filed on Jun. 16, 2022.

(51) Int. Cl. H04L 25/02; H04W 72/1263

(52) U.S. Cl. CPC H04L 25/0202; H04W 72/1263

(57) ABSTRACT

A method for generating a sequence is provided in the present disclosure. The method is applicable to a transmitter and the method includes: generating a target sequence initial seed based on target channel information, wherein the target channel information is channel information corresponding to a link between the transmitter and a receiver.

### CROSS-REFERENCE TO RELATED APPLICATION

This application is a continuation of International Application No. PCT/CN2022/099268, filed Jun. 16, 2022, the entire disclosure of which is incorporated herein by reference.

### TECHNICAL FIELD

Embodiments of the present disclosure relate to the technical field of communications, and in particular, relates to a method for generating a sequence, and a communication device thereof.

### BACKGROUND

In the 3^{rd} generation partnership project (3GPP), a scrambling sequence or reference signal may be generated based on a Gold sequence. The Gold sequence may be generated based on an initial seed Cᵢₙᵢₜ.

### SUMMARY

The embodiments of the present disclosure provide a method for generating a sequence and a communication device thereof.

According to some embodiments of the present disclosure, a method for generating a sequence is provided. The method is applicable to a transmitter. The method includes: generating a target sequence initial seed based on target channel information, wherein the target channel information is channel information corresponding to a link between the transmitter and a receiver.

According to some embodiments of the present disclosure, a communication device is provided. The communication device includes a memory and a processor. The memory is configured to store one or more computer programs, and the processor, when loading and running the one or more computer programs stored in the memory, is caused to perform: generating a target sequence initial seed based on target channel information, wherein the target channel information is channel information corresponding to a link between a transmitter and a receiver.

According to some embodiments of the present disclosure, a communication device is provided. The communication device includes a memory and a processor. The memory is configured to store one or more computer programs, and the processor, when loading and running the one or more computer programs stored in the memory, is caused to perform: generating a target sequence initial seed based on target channel information, wherein the target channel information is channel information corresponding to a link between a transmitter and a receiver.

### BRIEF DESCRIPTION OF DRAWINGS

FIG. 1 is a schematic diagram of a communication system architecture according to some embodiments of the present disclosure;

FIG. 2 is a schematic diagram of a method for generating a sequence according to some embodiments of the present disclosure;

FIG. 3 is a schematic diagram of another method for generating a sequence according to some embodiments of the present disclosure;

FIG. 4 is a schematic interactive diagram of a method for generating a sequence according to some embodiments of the present disclosure;

FIG. 5 is a schematic block diagram of a transmitter according to some embodiments of the present disclosure;

FIG. 6 is a schematic block diagram of a receiver according to some embodiments of the present disclosure;

FIG. 7 is a schematic block diagram of a communication device according to some embodiments of the present disclosure;

FIG. 8 is a schematic block diagram of a chip according to some embodiments of the present disclosure; and

FIG. 9 is a schematic block diagram of a communication system according to some embodiments of the present disclosure.

### DETAILED DESCRIPTION

The technical solutions according to the embodiments of the present disclosure will be described hereinafter in conjunction with the accompanying drawings in the embodiments of the present disclosure. The embodiments described are merely some embodiments of the present disclosure and not all of the embodiments. Based on the embodiments of the present disclosure, all other embodiments acquired by a person of ordinary skill in the art without making creative effort shall fall within protection scope of the present disclosure.

The technical solutions according to the embodiments of the present disclosure are applicable to various communication systems, for example, a global system of mobile communication (GSM), a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi) system, a 5^{th} generation (5G) system, or other communication systems.

Generally, a conventional communication system supports a limited number of connections and is easy to implement. However, with the development of communication technologies, a mobile communication system supports not only the traditional communications, but also other communications, such as device-to-device (D2D) communications, machine-to-machine (M2M) communications, machine-type communications (MTC), vehicle-to-vehicle (V2V) communications, and vehicle-to-everything (V2X) communications. The embodiments of the present disclosure are also applicable to these communication systems.

In some embodiments, the communication system in the embodiments of the present disclosure is applicable to a carrier aggregation (CA) scenario, a dual connectivity (DC) scenario, or a standalone (SA) networking scenario.

In some embodiments, the communication system according to the embodiments of the present disclosure is applicable to an unlicensed spectrum which may also be construed as a shared spectrum; or the communication system in the embodiments of the present disclosure is applicable to a licensed spectrum which may be construed as a non-shared spectrum.

Various embodiments are described in conjunction with a network device and a terminal device in the present disclosure. The terminal device refers to a user equipment (UE), an access terminal, a subscriber unit, a subscriber station, a mobile station, a mobile platform, a remote station, a remote terminal, a mobile device, a user terminal, a terminal, a wireless communication device, a user agent, or a user apparatus.

In some embodiments, the terminal device is a station (STA) in WLAN, a cellular phone, a cordless phone, a Session Initiation Protocol (SIP) phone, a wireless local loop (WLL) station, a personal digital assistant (PDA), a handheld device with a wireless communication function, a computing device or other processing devices connected to a wireless modem, an on-vehicle device, a wearable device, a terminal device in the next generation communication system such as the NR network, a terminal device in a future evolution public land mobile network (PLMN), or the like.

In the embodiments of the present disclosure, the terminal equipment may be deployed on land, including indoor or outdoor, hand-held, wearable or vehicle-mounted, may be deployed on water (e.g., a ship), or may be deployed in air (e.g., on an airplane, a balloon, a satellite).

In the embodiments of the present disclosure, the terminal device may be a mobile phone, tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device smart home, or the like.

By way of example rather than limitation, in the embodiments of the present disclosure, the terminal device may also be a wearable device. The wearable device may also be referred to as a wearable smart device, which is a generic term for wearable devices which are intelligently designed and developed on the basis of daily wear using the wearable technology, such as glasses, gloves, watches, clothing and shoes. The wearable device is a portable device that is worn directly or integrated into a user's clothing or accessories. The wearable device is not only a hardware device, but also capable of achieving powerful functions through software support, data interaction and cloud interaction. Generalized wearable smart devices include full-featured and large-sized devices that achieve all or part of functions without relying on a smartphone, i.e., smartwatches and smart glasses, and include devices that focus on a specific type of application functions and need to be used in conjunction with other devices such as a smartphone, e.g., various types of smart bracelets and smart jewelry that achieve physical signs monitoring.

In the embodiments of the present disclosure, the network device may be a device in communication with a mobile device, and the network device may be an access point (AP) in WLAN, a base transceiver station (BTS) in GSM or CDMA, a base station (NodeB, NB) in WCDMA, an evolutional NodeB (eNB or eNodeB) in LTE, a relay station, an access point, a vehicle device, a wearable device, a network device in the NR network (gNB), a network device in a future evolution PLMN network, a network device in the NTN network, or the like.

By way of example rather than limitation, in the embodiments of the present disclosure, the network device may have mobility, e.g., a mobile device. In some embodiments, the network device is a satellite or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network device is a base station deployed on land, water, or the like.

In the embodiments of the present disclosure, the network device is capable of providing a service for a cell, and the terminal device communicates with the network device over a transmission resource (such as a frequency domain resource or a frequency spectrum resource) used by the cell. The cell may be a cell corresponding to the network device (e.g., a base station), and the cell may belong to a macro base station or a base station corresponding to a small cell. The small cell includes a metro cell, a micro cell, a pico cell, a femto cell, or the like. These small cells have the characteristics of small coverage and low transmission power, and are applicable to providing high rate data transmission services.

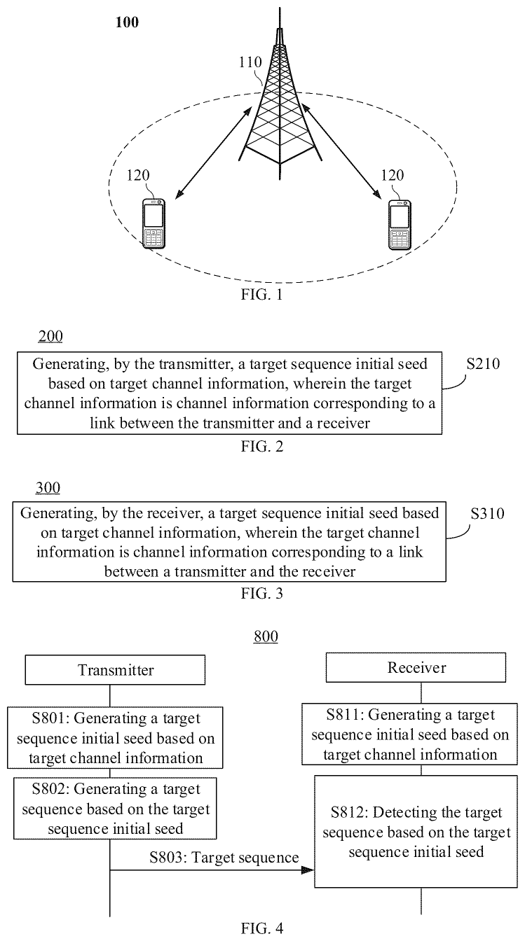

For example, the communication system 100 to which the embodiments of the present disclosure are applied is illustrated in FIG. 1. The communication system 100 includes a network device 110. The network device 110 is a device in communication with a terminal device 120 (which may also be referred to as a communication terminal or terminal). The network device 110 may provide communication coverage for a specific geographic region, and may communicate with terminal devices located within the coverage region.

FIG. 1 illustrates one network device and two terminal devices. In some embodiments, the communication system 100 includes a plurality of network devices, and coverage region of each of the plurality of network devices may include other numbers of terminal devices, which are not limited in the embodiments of the present disclosure.

In some embodiments, the communication system 100 further includes other network entities such as a network controller, a mobile management entity, and the like, which is not limited in the embodiments of the present disclosure.

It is understandable that the device having a communication function in the network/system in the embodiments of the present disclosure is referred to as a communication device. Using the communication system 100 illustrated in FIG. 1 as an example, the communication device includes a network device 110 and a terminal device 120, wherein the network device 110 and the terminal device 120 both have a communication function, and the network device 110 and the terminal device 120 are the specific devices as described above, which are not repeated herein. The communication device may further include other devices in the communication system 100, such as a network controller, a mobile management entity, and other network entities, which is not limited in the embodiments of the present disclosure.

It is understandable that terms “system” and “network” herein are interchangeably used in the present disclosure. The term “and/or” herein merely indicates an association relationship describing associated objects, that is, three types of relationships. For example, the phrase “A and/or B” indicates (A), (B), or (A and B). In addition, the character “/” generally indicates an “or” relationship between the associated objects.

It is understandable that the term “indicate” in the embodiments of the present disclosure means a direct indication, an indirect indication, or an associated relationship. For example, A indicating B, which mean that A indicates B directly, e.g., B is acquired by A; or that A indicates B indirectly, e.g., A indicates C, wherein B is acquired by C; or that an association relationship is present between A and B.

In the descriptions of the embodiments of the present disclosure, term “corresponding” may indicate a direct corresponding relationship or indirect corresponding relationship between two objects, or indicate an association relationship between two objects, or indicate relationships such as indicating and being indicated, configuring and being configured, or the like.

In the embodiments of the present disclosure, “predefined” is implemented by pre-storing a corresponding code, a table, or another manner that may indicate related information in the device (for example, the terminal device or the network device), and the specific implementations are not limited in the present disclosure. For example, the term “predefined” refers to “defined in protocols.”

In the embodiments of the present disclosure, the term “protocols” may refer to standards or protocols in the field of communications. For example, the protocols include LTE protocols, NR protocols, and other related protocols applicable to a future communication system, which are not limited in the present disclosure.

In the 3GPP, a corresponding scrambling sequence or reference signal is generated based on a length-31 Gold sequence. The length-31 Gold sequence c is generated as follows.

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${X}_{2} ( n + 31 ) = ( {x}_{2} ( n + 3 ) + {x}_{2} ( n + 2 ) + {x}_{2} ( n + 1 ) + {x}_{2} ( n ) ) mod 2$$

In this sequence, N_{C}=1600, an initial value of the first sequence x₁(n) is x₁(0)=1, x₁(n)=0, n=1, 2, . . . , 30, and an initial value of the second sequence x₂(n) is

$${c}_{init} = {\sum }_{i = 0}^{30} {x}_{2} ( i ) \cdot {2}^{i}$$

An initial seed Cᵢₙᵢₜ generated by a random sequence is generally determined based on one or more parameters such as time domain resource number and identification parameter. The identification parameter is configured to a terminal over a network or is predefined. The predefined identification parameter and time parameter are known to a non-target terminal. The identification parameter configured by a network device is exclusive to a target terminal. However, because the identification parameter is transmitted to the terminal device over an air interface, the identification parameter may be intercepted by the non-target terminal. Then, the non-target terminal acquires the initial seed, and knows the sequence transmitted to the target terminal. As a result, security risks including information leakage, theft, and imitation are caused.

For ease of understanding of the technical solutions according to the embodiments of the present disclosure, the technical solutions according to the present disclosure are described in detail in the following embodiments. The following related art may be used as optional solutions to be combined with the technical solutions according to the embodiments of the present disclosure, and all of the combinations fall within the protection scope of the embodiments of the present disclosure. The embodiments of the present disclosure include at least some of the following contents.

FIG. 2 is a schematic diagram of a method 200 for generating a sequence according to some embodiments of the present disclosure. The method 200 is applicable to a transmitter. Referring to FIG. 2, the method 200 includes the following processes.

In S210, the transmitter generates a target sequence initial seed based on target channel information.

In some embodiments, the target channel information refers to an exclusive parameter of a link between the transmitter and a receiver. That is, only the transmitter and receiver corresponding to the link know this parameter. Therefore, the target sequence initial seed generated based on this parameter can reduce information leakage.

In some embodiments, the target channel information is channel information of the link between the transmitter and the receiver. In some embodiments, the target channel information includes channel state information (CSI) of the link between the transmitter and the receiver, or includes other channel information of the link, which is not limited in the present disclosure.

In some embodiments, the channel state information includes, but is not limited to, at least one of: a channel quantity indicator (CQI), a rank indicator (RI), or a precoding matrix indicator (PMI).

In some embodiments, the transmitter and the receiver are both terminal devices.

In some other embodiments, the transmitter is a terminal device, and the receiver is a network device.

In some other embodiments, the transmitter is a network device, and the receiver is a terminal device.

In some embodiments, with respect to the transmitter, the target sequence initial seed is configured for generating a target sequence.

In some embodiments, the transmitter that transmits a target sequence generates a target sequence initial seed based on the target channel information, generates the target sequence based on the target sequence initial seed, and transmits the target sequence.

In some embodiments, with respect to the receiver, the target sequence initial seed is configured for detecting a target sequence.

In some embodiments, the receiver that receives a target sequence generates a target sequence initial seed based on the target channel information. By detecting the target sequence based on the target sequence initial seed, the receiver determines whether the transmitter transmits the target sequence, or the receiver performs a channel estimation.

It is understandable that in the embodiments of the present disclosure, the receiver generates the target sequence initial seed in the same way as the transmitter, and the generation of the target sequence initial seed is described hereinafter from the perspective of the transmitter, but the present disclosure is not limited thereto.

In some embodiments, the link between the transmitter and the receiver satisfies channel reciprocity. That is, it may be considered that the channel fading experienced by a signal transmitted by the transmitter to the receiver is the same as the channel fading experienced by a signal transmitted by the receiver to the transmitter. Alternatively, it may be considered that the target channel information determined by the transmitter is the same as the target channel information determined by the receiver.

In some embodiments, the target channel information includes channel information on N frequency domain units, wherein N is a positive integer.

In some embodiments, the frequency domain unit is a frequency point, or the frequency domain unit is frequency domain resources in a certain range. In some embodiments, the frequency domain unit includes, but is not limited to, at least one of: a subcarrier, a resource block (RB), a sub-band, a bandwidth part (BWP), or a carrier.

It is understandable that the method of acquiring the target channel information is not limited in the present disclosure. In some embodiments, the target channel information is acquired by channel measurement. For example, the target channel information is acquired by measuring a reference signal on the link between the transmitter and a receiver.

It should be noted that in embodiments of the present disclosure, the target channel information may be replaced with another exclusive parameter between the transmitter and the receiver, e.g., a characteristic parameter of the transmitter and a characteristic parameter of the receiver, such as a product number or a chip number, or another physical layer parameter between the transmitter and the receiver, which is not limited in the present disclosure.

In some embodiments of the present disclosure, the target sequence initial seed is generated based on the target channel information only, or generated based on the target channel information and another parameter such as a time parameter, a configuration parameter, or a predefined parameter, which is not limited in the present disclosure.

In some embodiments, the time parameter includes, but is not limited to, at least one of: a symbol, slot, subframe or frame occupied by the target sequence initial seed (or the target sequence).

In some embodiments, the configuration parameter is a parameter configured by the network device. In some embodiments, the configuration parameter includes, but is not limited to, a cell identifier.

In some embodiments, the predefined parameter is a parameter that is predefined, that is, the transmitter and the receiver knows the parameter without the need to configure the parameter by the network device. In some embodiments, the parameter is predefined by storing a corresponding code, table or other means that may be used to indicate the predefined parameter in the transmitter and the receiver in advance, and the specific implementation is not limited in the present disclosure. For example, the predefined parameter refers to a parameter defined in a protocol.

Hereinafter, the method for generating the target sequence initial seed is described in conjunction with Embodiment 1 and Embodiment 2.

Embodiment 1: The target sequence initial seed is generated based on target channel information.

In some embodiments of the present disclosure, S210 includes: generating the target sequence initial seed based on feature information (or characteristic information, or attribute information) of the target channel information.

In some embodiments, the feature information in the target channel information includes some or all features of the target channel information. For example, the target channel information is vector information, and the feature information in the target channel information includes feature information in the target channel information in a particular direction.

In some embodiments, the feature information in the target channel information includes, but is not limited to, at least one of: amplitude information in the target channel information, phase information in the target channel information, or mapping information (or projection information, or quantitation information) in the target channel information in a specific domain.

In some embodiments, the specific domain includes, but is not limited to, a Fourier transform (FT) domain. In some embodiments, the specific domain includes a fast Fourier transform (FTT) domain or a discrete Fourier transform (DFT) domain.

Embodiment 1-1: The target sequence initial seed is generated based on the amplitude information in the target channel information.

In some embodiments, generating the target sequence initial seed based on the feature information in the target channel information includes: generating the target sequence initial seed based on the amplitude information in the channel information on N frequency domain units.

In some embodiments, N quantized amplitude values are acquired by performing a quantization process on the amplitude information in the channel information on the N frequency domain units; and the target sequence initial seed is generated based on at least one quantized amplitude value of the N quantized amplitude values.

It is understandable that the quantization process performed on the amplitude information in the channel information on the N frequency domain units is not limited in the present disclosure.

As an example, the N quantized amplitude values are acquired by performing a binary quantization on the amplitude information in the channel information on the N frequency domain units based on a first amplitude threshold.

For example, in the case that the channel information H(n) on an n^{th} frequency domain unit of the N frequency domain units is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter performs the binary quantization on A(n) based on the first amplitude threshold Aₜₕ₁. For example, in the case that A(n) is greater than Aₜₕ₁, A(n) is quantized to A′(n)=1; otherwise, A(n) is quantized to A′(n)=0.

As another example, the N quantized amplitude values are acquired by rounding (e.g., rounding up or rounding down) the amplitude information in the channel information on the N frequency domain units.

For example, in the case that the channel information H(n) on an n^{th} frequency domain unit of the N frequency domain units is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter quantizes A(n) to A′(n)=┌A(n)┐ or A′(n)=└A(n)┘.

As another example, the N quantized amplitude values are acquired by performing a modulo process on the amplitude information in the channel information on the N frequency domain units with respect to a second amplitude threshold.

For example, in the case that the channel information H(n) on an n^{th} frequency domain unit of the N frequency domain units is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter performs the modulo and quantization on A(n) based on the second amplitude threshold Aₜₕ₂. For example, A(n) is quantized to A′(n)=A(n) mod Aₜₕ₂.

Further, in some embodiments, the transmitter takes one quantized amplitude value of the N quantized amplitude values as the target sequence initial seed, or generates the target sequence initial seed based on the plurality of quantized amplitude values. For example, the target sequence initial seed is acquired by processing the plurality of quantized amplitude values, wherein the processing method includes, but is not limited to, an accumulation process, a multiplication process, the Fourier transform process, the modulo process, or the like.

As an example, the transmitter generates the target sequence initial seed according to the following formula: C=Σᵢ₌₀^{Q}A′(i)·2ⁱ, wherein C represents the target sequence initial seed, A′(i) represents the quantized amplitude value of the channel information on the i^{th} frequency domain unit of the N frequency domain units, Q is an integer, and A′(n) represents the quantized amplitude value of the channel information on the n^{th} frequency domain unit of the N frequency domain units.

Embodiment 1-2: The target sequence initial seed is generated based on the phase information in the target channel information.

In some embodiments, generating the target sequence initial seed based on the feature information in the target channel information includes: generating the target sequence initial seed based on the phase information in the channel information on the N frequency domain units.

In some embodiments, N quantized phase values are acquired by performing a quantization process on the phase information in the channel information on the N frequency domain units; and the target sequence initial seed is generated based on at least one quantized phase value of the N quantized phase values.

It is understandable that the quantization process performed on the phase information in the channel information on the N frequency domain units is not limited in the present disclosure.

As an example, the N quantized phase values are acquired by performing a binary quantization on the phase information in the channel information on the N frequency domain units based on a first phase threshold.

For example, in the case that the channel information H(n) on the n^{th} frequency domain unit of the N frequency domain units is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter performs the binary quantization on θ(n) based the first phase threshold θₜₕ₁. For example, in the case that θ(n) is greater than θₜₕ₁, θ(n) is quantized to θ′(n)=1; otherwise, θ(n) is quantized to θ′(n)=0.

As another example, the N quantized phase values are acquired by rounding (e.g., rounding up or rounding down) the phase information in the channel information on the N frequency domain units.

For example, in the case that the channel information H(n) on an n^{th} frequency domain unit of the N frequency domain units is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter quantizes θ(n) to θ′(n)=┌θ(n)┐ or θ′(n)=└θ(n)┘.

As another example, the N quantized phase values are acquired by performing the modulo process on the phase information in the channel information on the N frequency domain units with respect to a second phase threshold.

For example, in the case that the channel information H (n) on an n^{th} frequency domain unit of the N frequency domain units is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter performs the modulo and quantization on θ(n) based on the second phase threshold θₜₕ₂. For example, θ(n) is quantized to θ′(n)=θ(n) mod θₜₕ₂.

In some embodiments, the transmitter takes one quantized phase value of the N quantized phase values as the target sequence initial seed, or generates the target sequence initial seed based on the plurality of quantized phase values. For example, the target sequence initial seed is acquired by processing the plurality of quantized phase values, wherein the processing method includes, but is not limited to, the accumulation process, the multiplication process, the Fourier transform process, the modulo process, or the like.

As an example, the transmitter generates the target sequence initial seed according to the following formula: C=Σᵢ₌₀^{P}θ′(i)·2ⁱ, wherein C represents the target sequence initial seed, θ′(i) represents the quantized phase value of the channel information on the i^{th} frequency domain unit of the N frequency domain units, P is an integer, and θ′(n) represents the quantized phase value of the channel information on the n^{th} frequency domain unit of the N frequency domain units.

Embodiment 1-3: The target sequence initial seed is generated based on the mapping information in the target channel information in the specific domain.

The following description takes an example where the specific domain is the FFT domain, but the present disclosure is not limited thereto.

In some embodiments of the present disclosure, S210 includes: generating the target sequence initial seed based on the mapping information in the channel information on the N frequency domain units in the Fourier transform domain.

In some embodiments, the codebook is considered as the FFT domain, and the mapping information in the target channel information in the FFT domain is characterized by the codebook mapped by the target channel information in the FFT domain.

In some embodiments, the transmitter determines, based on the channel information on each frequency domain unit of the N frequency domain units, a target codebook corresponding to the channel information on each frequency domain unit from a candidate codebook set. Index information of the target codebook corresponding to the channel information on each frequency domain unit indicates the mapping information in the channel information on each frequency domain unit in the Fourier transform domain.

Further, the transmitter generates the first sequence initial seed based on the index information of the target codebook corresponding to the channel information on at least one frequency domain unit of the N frequency domain units.

It is understandable that, in the embodiments of the present disclosure, “at least one” refers to one or more, and “plurality” refers to two or more.

It is understandable that the specific manner of determining the target codebook corresponding to the channel information on each frequency domain unit from the candidate codebook set is not limited in the embodiments of the present disclosure. In some embodiments, the target codebook is determined based on an inner product of the channel information on the frequency domain unit and a candidate codebook in the candidate codebook set. In one embodiment, in the candidate codebook set, the codebook which has the largest inner product with the channel information on the frequency domain unit is determined as the target codebook. In another embodiment, in the candidate codebook set, the codebook which has the smallest inner product with the channel information on the frequency domain unit is determined as the target codebook.

For example, in the case that the channel information on the n^{th} frequency domain unit of the N frequency domain units H_{a*b}(n) is expressed by:
H_{a*b}(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, a represents a transmitting antenna, and b represents a receiving antenna, then the transmitter determines a target codebook adapted to the channel information H_{a*b}(n) from the candidate codebook set. In the candidate codebook set, the inner product of the target codebook and the channel information H_{a*b}(n) is the largest.

For example, as illustrated in table 1, the candidate codebook set includes a candidate codebook set consisting of 256 codebooks, and the index i₁,i₂ (corresponding to the above index information) corresponding to each of the codebooks may be used to represent the codebook. The target codebook corresponding to the channel information on the n^{th} frequency domain unit of the N frequency domain units is identified by i₁(n), i₂(n). In this case, the index i₁(n), i₂(n) corresponding to the codebook is taken as the mapping information in the channel information on the n^{th} frequency domain unit in the FFT domain.

TABLE 1

| | i₂ | | | | | | | |
|---|---|---|---|---|---|---|---|---|
| i₁ | 0 | 1 | 2 | 3 | 4 | 5 | 6 | 7 |
| 0-15 | Wᵢ_{₁}_{,0}⁽¹⁾ | Wᵢ_{₁}_{,8}⁽¹⁾ | Wᵢ_{₁}_{,16}⁽¹⁾ | Wᵢ_{₁}_{,24}⁽¹⁾ | Wᵢ_{₁}_{+8,2}⁽¹⁾ | Wᵢ_{₁}_{+8,10}⁽¹⁾ | Wᵢ_{₁}_{+8,18}⁽¹⁾ | Wᵢ_{₁}_{+8,26}⁽¹⁾ |
| | i₂ | | | | | | | |
| i₁ | 8 | 9 | 10 | 11 | 12 | 13 | 14 | 15 |
| 0-15 | Wᵢ_{₁}_{+16,4}⁽¹⁾ | Wᵢ_{₁}_{+16,12}⁽¹⁾ | Wᵢ_{₁}_{+16,20}⁽¹⁾ | Wᵢ_{₁}_{+16,28}⁽¹⁾ | Wᵢ_{₁}_{+24,6}⁽¹⁾ | Wᵢ_{₁}_{+24,14}⁽¹⁾ | Wᵢ_{₁}_{+24,22}⁽¹⁾ | Wᵢ_{₁}_{+24,30}⁽¹⁾ |

$wherein , {W}_{m , n}^{( 1 )} = \frac{1}{2} [ \begin{matrix}{v}_{m}^{′} \\ {φ}_{n}^{′} , {v}_{m}^{′}\end{matrix} ] , \begin{matrix}{φ}_{n} = {e}^{j π n / 2} \\ {φ}_{n}^{′} = {e}^{j 2 π n / 32} \\ {v}_{m}^{′} = [ \begin{matrix}1 & {{e}^{j 2 π n / 32} ]}^{T}\end{matrix}\end{matrix}$

The specific value of the codebook may be determined based on the index i₁,i₂ of the codebook in combination with the mapping information illustrated in table 1. In some embodiments, the values of m and n in W_{m,n}⁽¹⁾ may be determined based on the value of index i₁,i₂ in combination with the mapping information illustrated in table 1. For example, in the case that i₁ is 0-15, and i₂ is 0, the value of m is i₁, and the value of n is 0. Accordingly, the specific value of W_{m,n}⁽¹⁾ may be determined according to formula:

$${W}_{m , n}^{( 1 )} = \frac{1}{2} [ \begin{matrix}{v}_{m}^{′} \\ {φ}_{n}^{′} {v}_{m}^{′}\end{matrix} ] ,$$

$${φ}_{n} = {e}^{j π n / 2}$$

$${φ}_{n}^{′} = {e}^{j 2 π n / 32}$$

$${v}_{m}^{′} = [ \begin{matrix}1 & {{e}^{j 2 π n / 32} ]}^{T} .\end{matrix}$$

In some embodiments, generating the target sequence initial seed based on the index information of the target codebook corresponding to the channel information on the at least one frequency domain unit of the N frequency domain units includes: generating the target sequence initial seed according to the following formula:
C=Σₗ₌₀^{X}i₁(l)·15^{l}+Σₗ₌₀^{X}i₂(l)·15^{l}, wherein C represents the target sequence initial seed, i₁(l) and i₂(l) represent the index information of the target codebook corresponding to the channel information on an i^{th} frequency domain unit of the N frequency domain units, X represents the number of the at least one frequency domain unit minus 1, and X is an integer.

It is understandable that the above embodiment 1-1 to embodiment 1-3 may be implemented individually or in combination. In some embodiments, the transmitter generates the target sequence initial seed based on the amplitude information and the phase information in the target channel information, or generates the target sequence initial seed based on the amplitude information and the mapping information in a particular domain of the target channel, or generates the target sequence initial seed based on the amplitude information, the phase information, the mapping information in a particular domain of the target channel, or the like. As an example, the target sequence initial seed is generated according to the following formula:

$$C = {\sum }_{l = 0}^{X} {i}_{1} ( l ) \cdot {15}^{l} + {\sum }_{l = 0}^{X} {i}_{2} ( l ) \cdot {15}^{l} + {\sum }_{i = 0}^{Q} {A}^{′} ( i ) \cdot {2}^{i} + {\sum }_{i = 0}^{P} {θ}^{′} ( i ) \cdot {2}^{i} .$$

wherein C represents the target sequence initial seed, i₁(l) and i₂(l) represent the index information of the target codebook corresponding to the channel information on the i^{th} frequency domain unit of the N frequency domain units, A′(n) represents the amplitude information in the channel information on the n^{th} frequency domain unit of the N frequency domain units, θ′(i) represents the phase information in the channel information on the n^{th} frequency domain unit of the N frequency domain units, X represents the number of the at least one frequency domain unit minus 1, and X, Q and P are integers.

It is understandable that, in the embodiments of the present disclosure, the target channel information includes channel information on N frequency domain units, or includes channel information on M other domain units (e.g., spatial domain), which is not limited in the present disclosure.

Embodiment 2: The target sequence initial seed is generated based on the target channel information and another parameter.

In some embodiments, the transmitter generates the target sequence initial seed based on the target channel information and a first parameter. The first parameter includes at least one of a time parameter, a configuration parameter, or a predefined parameter.

In some embodiments, the transmitter generates a first sequence initial seed based on the target channel information, and generates the target sequence initial seed based on the first sequence initial seed and the first parameter.

In some embodiments, the target sequence initial seed is generated by performing an accumulate operation, a multiply operation, a modulo operation, a Fourier transform operation or the like on the first sequence initial seed and the first parameter.

In some other embodiments, the transmitter generates a second sequence initial seed based on the first parameter, and generates the target sequence initial seed based on the second sequence initial seed and the target channel information. For example, the transmitter generates the target sequence initial seed based on the second sequence initial seed and the feature information in the target channel information.

It is understandable that, for the specific implementation of generating the first sequence initial seed based on the target channel information in embodiment 2, reference may be made to the relevant implementation of generating the target sequence initial seed based on the target channel information in embodiment 1, and details are not repeated herein for brevity.

For example, the first sequence initial seed is generated based on the feature information in the target channel information.

As an example, the first sequence initial seed is generated based on at least one of the amplitude information, the phase information, or the mapping information in a specific domain of the target channel information.

Embodiment 2-1: The target sequence initial seed is generated based on the target channel information and the time parameter.

In some embodiments, the transmitter quantizes the channel information on N frequency domain units included in the target channel information, and generates the target sequence initial seed based on the time parameter and the quantized channel information.

For example, in the case that the channel information on an n^{th} frequency domain unit of the N frequency domain units H (n) is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter acquires H′(n) by quantizing H(n). For the specific implementation of quantization, please refer to the specific implementation in embodiment 1. Further, the transmitter acquires the first sequence initial seed M by processing H′(n), n=0, 1, . . . N. For example, M=f(H′(n)), wherein f is a function, e.g., an accumulation function, a multiplication function, or a Fourier transform function, which is not limited in the present disclosure.

Further, the transmitter acquires the target sequence initial seed according to formula: C=g(M, T), wherein g represents a sequence generation function, e.g., an accumulation function, a multiplication function, a modulo function, a Fourier transform function, or the like; T represents a time parameter, wherein the time parameter may be a symbol where the target sequence is located, a slot where the target sequence is located, a subframe where the target sequence is located, an index of a frame where the target sequence is located, or the like.

As an example, the target sequence initial seed C is generated according to the following formula:

$$C = ( {2}^{17} ( {N}_{symb}^{slot} {n}_{s , f}^{μ} + l + 1 ) ( 2 M + 1 ) + 2 M ) mod {2}^{31}$$

In this formula, l represents the serial number of the orthogonal frequency-division multiplexing (OFDM) symbol, N_{symb}^{slot} represents the number of symbols in one slot, and n_{s,f}^{μ} represents the slot serial number in a radio frame.

In embodiment 2-1, in the case that the target sequence initial seed is generated, the time-varying nature of the target sequence is increased by introducing the time parameter, such that it is hard to track and decipher the target sequence, and the interference is randomized, thereby reducing the security risk of information leakage.

Embodiment 2-2: The target sequence initial seed is generated based on the target channel information, the time parameter, and the configuration parameter.

In some embodiments, the transmitter quantizes the channel information on N frequency domain units included in the target channel information, and generates the target sequence initial seed based on the time parameter, the configuration parameter, and the quantized channel information.

For example, in the case that the channel information on the n^{th} frequency domain unit of the N frequency domain units H(n) is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter acquires H′(n) by quantizing H(n) For the specific implementation of quantization, please refer to the specific implementation in embodiment 1. Further, the transmitter acquires the first sequence initial seed M by processing H′(n), n=0, 1, . . . N. For example, M=f(H′(n)), wherein f is a function, e.g., an accumulation function, a multiplication function, or a Fourier transform function, which is not limited in the present disclosure.

Further, the transmitter acquires the target sequence initial seed according to formula: C=g(M, T, P), wherein g represents a sequence generation function, e.g., an accumulation function, a multiplication function, a modulo function, a Fourier transform function, or the like; T represents a time parameter, wherein the time parameter may be a symbol where the target sequence is located, a slot where the target sequence is located, a subframe where the target sequence is located, an index of a frame where the target sequence is located, or the like; and P represents a configuration parameter.

As an example, the target sequence initial seed C is generated according to the following formula:

$$C = ( {2}^{17} ( {N}_{symb}^{slot} {n}_{s , f}^{μ} + l + 1 ) ( 2 M + 1 ) + 2 M + P ) mod {2}^{31}$$

In this formula, l represents the serial number of OFDM symbol, N_{symb}^{slot} represents the number of symbols in one slot, n_{s,f}^{μ} represents the slot serial number in a radio frame, and P represents a configuration parameter.

In embodiment 2-2, in the case that the target sequence initial seed is generated, the time-varying nature of the target sequence is increased by introducing the time parameter, such that it is hard to track and decipher the target sequence, and the interference is randomized, thereby reducing the security risks. By introducing the configuration parameter configured by the network device, the network device is capable of controlling the allocation of sequence resources, thereby facilitating coordination or elimination of the interference.

Embodiment 2-3: The target sequence initial seed is generated based on the target channel information, the time parameter, and the predefined parameter.

In some embodiments, the transmitter quantizes the channel information on N frequency domain units included in the target channel information, and generates the target sequence initial seed based on the time parameter, the predefined parameter, and the quantized channel information.

For example, in the case that the channel information on the n^{th} frequency domain unit of the N frequency domain units H(n) is expressed by:
H(n)=A(n)e^{jθ(n)}, n=0, 1, 2 . . . N−1, wherein A(n) represents the amplitude information in the channel information on the n^{th} frequency domain unit, θ(n) represents the phase information in the channel information on the n^{th} frequency domain unit, then the transmitter acquires H′(n) by quantizing H(n) For the specific implementation of quantization, please refer to the specific implementation in embodiment 1. Further, the transmitter acquires the first sequence initial seed M by processing H′(n), n=0, 1, . . . N. For example, M=f(H′(n)) wherein f is a function, e.g., an accumulation function, a multiplication function, or a Fourier transform function, which is not limited in the present disclosure.

Further, the transmitter acquires the target sequence initial seed according to formula: C=g(M, T, Y), wherein g represents a sequence generation function, e.g., an accumulation function, a multiplication function, a modulo function, a Fourier transform function, or the like; T represents a time parameter, wherein the time parameter may be a symbol where the target sequence is located, a slot where the target sequence is located, a subframe where the target sequence is located, an index of a frame where the target sequence is located, or the like; and Y represents a predefined parameter.

As an example, the target sequence initial seed C is generated according to the following formula:

$$C = ( {2}^{17} ( {N}_{symb}^{slot} {n}_{s , f}^{μ} + l + 1 ) ( 2 M + 1 ) + 2 M + Y ) mod {2}^{31}$$

In this formula, l represents the serial number of OFDM symbol, N_{symb}^{slot} represents the number of symbols in one slot, n_{s,f}^{μ} represents the slot serial number in a radio frame, and Y represents a predefined parameter.

In some embodiments of the present disclosure, the method 200 further includes: generating a target sequence based on the target sequence initial seed; and transmitting the target sequence to the receiver.

In some embodiments of the present disclosure, the target sequence is a scrambling sequence or a reference signal sequence, which is not limited in the present disclosure.

For example, the target sequence is a demodulation reference signal (DMRS) sequence, a channel state information reference signal (CSI-RS) sequence, or the like.

In summary, according to the embodiments of the present disclosure, the transmitter or the receiver is capable of generating the target sequence initial seed based on the target channel information corresponding to the link between the two. Because the target channel information is an exclusive parameter between the transmitter and the receiver and cannot be known by other devices, the target sequence initial seed determined based on the target channel information is extremely secure, thereby reducing the security risk of information leakage.

Furthermore, the transmitter or the receiver is capable of generating the target sequence initial seed based on the target channel information and another parameter, such as the time parameter and the configuration parameter. By introducing the time parameter, the time-varying nature of the target sequence is increased, such that the target sequence is not easy to be tracked and deciphered, and the interference is randomized, thereby reducing the security risk. By introducing the configuration parameter configured by the network device, the network device is capable of controlling the allocation of sequence resources, thereby facilitating coordination or elimination of the interference.

The method for generating the sequence according to some embodiments of the present disclosure is described in detail above in combination with FIG. 2 from the perspective of the transmitter, and the method for generating the sequence according to some other embodiments of the present disclosure is described in detail hereinafter in combination with FIG. 3 from the perspective of the receiver. It is understandable that the descriptions on the side of the receiver corresponds to the descriptions on the side of the transmitter, and similar descriptions may be found above and are not repeated herein to avoid repetition.

FIG. 3 is a schematic flow diagram of a method 300 for generating a sequence according to some embodiments of the present disclosure. The method is applicable to a receiver. Referring to FIG. 3, the method 300 includes the following processes.

In S310, the receiver generates a target sequence initial seed based on target channel information, wherein the target channel information is channel information corresponding to a link between a transmitter and the receiver.

It is understandable that the method for generating the target sequence initial seed by the receiver is the same as the method for generating the target sequence initial seed by the transmitter. For the specific implementation, please refer to the relevant descriptions in the method 200, and details are not repeated herein for brevity.

In some embodiments of the present disclosure, S310 includes: generating a first sequence initial seed based on the target channel information; and determining the first sequence initial seed as the target sequence initial seed.

In some embodiments of the present disclosure, generating the target sequence initial seed based on the target channel information includes: generating the target sequence initial seed based on the target channel information and a first parameter, wherein the first parameter includes at least one of a time parameter, a configuration parameter, or a predefined parameter.

In some embodiments of the present disclosure, generating the target sequence initial seed based on the target channel information and the first parameter includes: generating a first sequence initial seed based on the target channel information; and generating the target sequence initial seed based on the first sequence initial seed and the first parameter.

In some embodiments of the present disclosure, generating the target sequence initial seed based on the first sequence initial seed and the first parameter includes: generating the target sequence initial seed by performing an accumulate operation, a modulo operation, or a Fourier transform operation on the first sequence initial seed and the first parameter.

In some embodiments, the time parameter includes at least one of: a symbol occupied by the target sequence initial seed, a slot occupied by the target sequence initial seed, a subframe occupied by the target sequence initial seed, or a frame occupied by the target sequence initial seed.

In some embodiments, generating the first sequence initial seed based on the target channel information includes: generating the first sequence initial seed based on feature information in the target channel information.

In some embodiments, the feature information in the target channel information includes at least one of: amplitude information of the target channel information, phase information in the target channel information, or mapping information in the target channel information in a specific domain.

In some embodiments, the target channel information includes channel information on N frequency domain units, wherein N is a positive integer.

In some embodiments, generating the first sequence initial seed based on the target channel information includes: generating the first sequence initial seed based on the amplitude information in the channel information on the N frequency domain units.

For example, N quantized amplitude values are acquired by performing a quantization process on the amplitude information in the channel information on the N frequency domain units; and the first sequence initial seed is generated based on at least one quantized amplitude value of the N quantized amplitude values.

As an example, the N quantized amplitude values are acquired by performing a binary quantization on the amplitude information in the channel information on the N frequency domain units based on a first amplitude threshold.

As another example, the N quantized amplitude values are acquired by rounding the amplitude information in the channel information on the N frequency domain units.

As another example, the N quantized amplitude values are acquired by performing a modulo process on the amplitude information in the channel information on the N frequency domain units with respect to a second amplitude threshold.

In some embodiments, the first sequence initial seed is generated according to the following formula:

$$C = {\sum }_{i = 0}^{Q} {A}^{′} ( i ) \cdot {2}^{i}$$

$$or$$

$$C = {A}^{′} ( n )$$

wherein C represents a sequence initial seed, A′(i) represents an quantized amplitude value of channel information on an i^{th} frequency domain unit of the N frequency domain units, Q represents the number of the at least one quantized amplitude value minus 1, Q is an integer, and A′(n) represents an quantized amplitude value of the channel information on an n^{th} frequency domain unit of the N frequency domain units, wherein 0≤n≤N−1.

In some embodiments, generating the first sequence initial seed based on the target channel information includes: generating the first sequence initial seed based on the phase information in the channel information on the N frequency domain units.

For example, N quantized phase values are acquired by performing a quantization process on the phase information in the channel information on the N frequency domain units, and the first sequence initial seed is generated based on at least one quantized phase value of the N quantized phase values.

As an example, the N quantized phase values are acquired by performing a binary quantization on the phase information in the channel information on the N frequency domain units based on a first phase threshold.

As another example, the N quantized phase values are acquired by rounding the phase information in the channel information on the N frequency domain units.

As another example, the N quantized phase values are acquired by performing a modulo process on the phase information in the channel information on the N frequency domain units with respect to a second phase threshold.

For example, the first sequence initial seed is generated according to the following formula:

$$C = {\sum }_{i = 0}^{P} {θ}^{′} ( i ) \cdot {2}^{i}$$

$$or$$

$$C = {θ}^{′} ( n )$$

wherein C represents a sequence initial seed, θ′(i) represents a quantized phase value in channel information on an i^{th} frequency domain unit, P represents the number of the at least one quantized phase value minus 1, P is an integer, and θ′(n) represents a quantized phase value of channel information on an n^{th} frequency domain unit of the N frequency domain units, wherein 0≤n≤N−1.

In some other embodiments, generating the first sequence initial seed based on the target channel information includes: generating the first sequence initial seed based on mapping information in the channel information on the N frequency domain units in a Fourier transform domain.

For example, a target codebook corresponding to the channel information on each frequency domain unit is determined from a candidate codebook set based on the channel information on each frequency domain unit of the N frequency domain units, wherein index information of the target codebook corresponding to the channel information on each frequency domain unit indicates the mapping information in the channel information on each frequency domain unit in the Fourier transform domain. Further, the first sequence initial seed is generated based on the index information of the target codebook corresponding to the channel information on at least one frequency domain unit of the N frequency domain units.

For example, the sequence initial seed is generated according to the following formula:

$$C = {\sum }_{l = 0}^{X} {i}_{1} ( l ) \cdot {15}^{l} + {\sum }_{l = 0}^{X} {i}_{2} ( l ) \cdot {15}^{l}$$

wherein C represents the sequence initial seed, i₁(l) and i₂(l) represent the index information of the target codebook corresponding to the channel information on an i^{th} frequency domain unit of the N frequency domain units, X represents the number of the at least one frequency domain unit minus 1, and X is an integer.

In some embodiments, in the candidate codebook set, an inner product of the target codebook and the channel information on the frequency domain unit is the largest.

In some embodiments, the method 300 further includes: detecting a target sequence based on the target sequence initial seed.

For example, the receiver detects whether the transmitter transmits the target sequence based on the target sequence initial seed, or the receiver performs a channel estimation based on the target sequence initial seed.

Hereinafter, a method for generating a sequence according to some embodiments of the present disclosure is described in combination with FIG. 4 from the perspective of device interaction. As illustrated in FIG. 4, the method includes at least some of the following processes.

In S801, a transmitter generates a target sequence initial seed based on target channel information.

For the specific implementation, please refer to the relevant descriptions of S210, and details are not repeated herein for brevity.

In S811, the receiver generates a target sequence initial seed based on target channel information.

For the specific implementation, please refer to the relevant descriptions of S210, and details are not repeated herein for brevity.

In S802, the transmitter generates a target sequence based on the target sequence initial seed.

For example, the target sequence C is generated according to the following formula:

$$c ( n ) = ( {x}_{1} ( n + {N}_{C} ) + {x}_{2} ( n + {N}_{C} ) ) mod 2$$

$${x}_{1} ( n + 31 ) = ( {x}_{1} ( n + 3 ) + {x}_{1} ( n ) ) mod 2$$

$${x}_{2} ( n + 31 ) = ( {x}_{2} ( n + 3 ) + {x}_{2} ( n + 2 ) + {x}_{2} ( n + 1 ) + {x}_{2} ( n ) ) mod 2$$

wherein N_{C}=1600, an initial value of the first sequence x₁(n) is x₁(0)=1, x₁(n)=0, n=1, 2, . . . , 30, an initial value of the second sequence x₂(n) is

$${c}_{init} = {\sum }_{i = 0}^{30} {x}_{2} ( i ) \cdot {2}^{i} ,$$

and the initial value of the second sequence x₂(n) is the foregoing the target sequence initial seed.

In S803, the transmitter transmits the target sequence to the receiver.

Accordingly, in S812, the receiver detects the target sequence based on the target sequence initial seed.

It is understandable that the timing relationship among S802, S803 and S812 in FIG. 4 is an example only, and the present disclosure is not limited thereto.

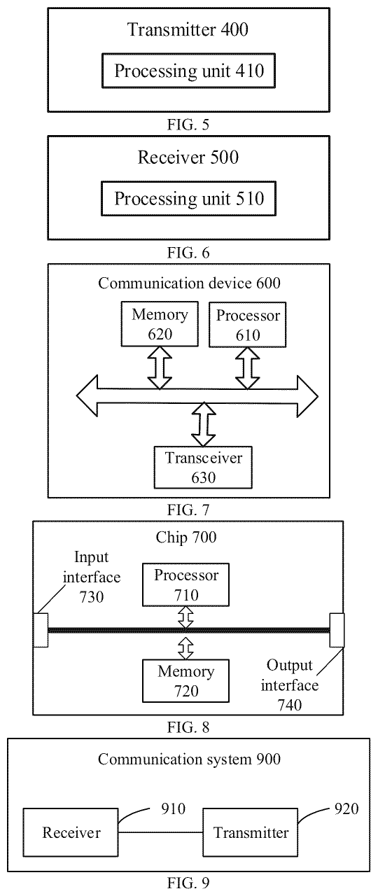

The method embodiments of the present disclosure are described in detail above in combination with FIGS. 2 to 4, and apparatus embodiments of the present disclosure are described in detail hereinafter in combination with FIGS. 5 to 8. It is understandable that the apparatus embodiments correspond to the method embodiments, and that similar descriptions may be made with reference to the method embodiments.

FIG. 5 is a schematic block diagram of a transmitter 400 according to some embodiments of the present disclosure. Referring to FIG. 5, the transmitter 400 includes:
a processing unit 410, configured to generate a target sequence initial seed based on target channel information, wherein the target channel information is channel information corresponding to a link between the transmitter and a receiver.

In some embodiments, the processing unit 410 is further configured to: generate a first sequence initial seed based on the target channel information; and determine the first sequence initial seed as the target sequence initial seed.

In some embodiments, the processing unit 410 is further configured to: generate the target sequence initial seed based on the target channel information and a first parameter, wherein the first parameter includes at least one of a time parameter, a configuration parameter, or a predefined parameter.

In some embodiments, the processing unit 410 is further configured to: generate a first sequence initial seed based on the target channel information; and generate the target sequence initial seed based on the first sequence initial seed and the first parameter.

In some embodiments, the processing unit 410 is further configured to: generate the target sequence initial seed by performing an accumulate operation, a modulo operation, or a Fourier transform operation on the first sequence initial seed and the first parameter.

In some embodiments, the time parameter includes at least one of: a symbol occupied by the target sequence initial seed, a slot occupied by the target sequence initial seed, a subframe occupied by the target sequence initial seed, or a frame occupied by the target sequence initial seed.

In some embodiments, the processing unit 410 is further configured to: generate the first sequence initial seed based on feature information in the target channel information.

In some embodiments, the feature information in the target channel information includes at least one of: amplitude information in the target channel information, phase information in the target channel information, or mapping information in the target channel information in a specific domain.

In some embodiments, the specific domain includes a FFT domain.

In some embodiments, the target channel information includes channel information on N frequency domain units, wherein N is a positive integer.

In some embodiments, the frequency domain unit includes at least one of: a subcarrier, a RB, a sub-band, a BWP, or a carrier.

In some embodiments, the processing unit 410 is further configured to: generate the first sequence initial seed based on amplitude information in the channel information on the N frequency domain units.

In some embodiments, the processing unit 410 is further configured to: acquire N quantized amplitude values by performing a quantization process on the amplitude information in the channel information on the N frequency domain units; and generate the first sequence initial seed based on at least one quantized amplitude value of the N quantized amplitude values.

In some embodiments, the processing unit 410 is further configured to:
acquire the N quantized amplitude values by performing a binary quantization on the amplitude information in the channel information on the N frequency domain units based on a first amplitude threshold; or
acquire the N quantized amplitude values by rounding the amplitude information in the channel information on the N frequency domain units; or
acquire the N quantized amplitude values by performing a modulo process on the amplitude information in the channel information on the N frequency domain units with respect to a second amplitude threshold.

In some embodiments, the processing unit 410 is further configured to: generate the first sequence initial seed according to the following formula:

$$C = {\sum }_{i = 0}^{Q} {A}^{′} ( i ) \cdot {2}^{i}$$

$$or$$

$$C = {A}^{′} ( n )$$

wherein C represents the first sequence initial seed, A′(i) represents an quantized amplitude value of the channel information on an i^{th} frequency domain unit of the N frequency domain units, Q represents the number of the at least one quantized amplitude value minus 1, Q is an integer, and A′(n) represents an quantized amplitude value of the channel information on an n^{th} frequency domain unit of the N frequency domain units, wherein 0≤n≤N−1.

In some embodiments, the processing unit 410 is further configured to: generate the first sequence initial seed based on phase information in the channel information on the N frequency domain units.

In some embodiments, the processing unit 410 is further configured to: acquire N quantized phase values by performing a quantization process on the phase information in the channel information on the N frequency domain units; and generate the first sequence initial seed based on at least one quantized phase value of the N quantized phase values.

In some embodiments, the processing unit 410 is further configured to:
acquire the N quantized phase values by performing a binary quantization on the phase information in the channel information on the N frequency domain units based on a first phase threshold; or
acquire the N quantized phase values by rounding the phase information in the channel information on the N frequency domain units; or
acquire the N quantized phase values by performing a modulo process on the phase information in the channel information on the N frequency domain units with respect to a second phase threshold.

In some embodiments, the processing unit 410 is further configured to: generating the first sequence initial seed according to the following formula:

$$C = {\sum }_{i = 0}^{P} {θ}^{′} ( i ) \cdot {2}^{i}$$

$$or$$

$$C = {θ}^{′} ( n )$$

wherein C represents the first sequence initial seed, θ′(i) represents a quantized phase value of the channel information on an i^{th} frequency domain unit, P represents the number of the at least one quantized phase value minus 1, P is an integer, and θ′(n) represents a quantized phase value of the channel information on an n^{th} frequency domain unit of the N frequency domain units, wherein 0≤n≤N−1.

In some embodiments, the processing unit 410 is further configured to: generate the first sequence initial seed based on the mapping information in the channel information on the N frequency domain units in a Fourier transform domain.

In some embodiments, the processing unit 410 is further configured to:
determine, based on the channel information on each frequency domain unit of the N frequency domain units, a target codebook corresponding to the channel information on each frequency domain unit from a candidate codebook set, wherein index information of the target codebook corresponding to the channel information on each frequency domain unit indicates the mapping information in the channel information on each frequency domain unit in the Fourier transform domain; and
generate the first sequence initial seed based on the index information of the target codebook corresponding to the channel information on at least one frequency domain unit of the N frequency domain units.

In some embodiments, the processing unit 410 is further configured to: generate the first sequence initial seed according to the following formula:

$$C = {\sum }_{l = 0}^{X} {i}_{1} ( l ) \cdot {15}^{l} + {\sum }_{l = 0}^{X} {i}_{2} ( l ) \cdot {15}^{l}$$

wherein C represents the first sequence initial seed, i₁(l) and i₂(l) represent the index information of the target codebook corresponding to the channel information on an i^{th} frequency domain unit of the N frequency domain units, X represents the number of the at least one frequency domain unit minus 1, and X is an integer.

In some embodiments, in the candidate codebook set, an inner product of the target codebook and the channel information on the frequency domain unit is the largest.

In some embodiments, the processing unit 410 is further configured to: generate a target sequence based on the target sequence initial seed.

In some embodiments, the transmitter further includes a communication unit, wherein the communication unit is configured to transmit the target sequence to the receiver.

In some embodiments, the communication unit is a communication interface, a transceiver, a communication chip, or an input/output interface of system-on-chip; and the processing unit is one or more processors.

It is understandable that the transmitter 400 according to the embodiments of the present disclosure corresponds to the transmitter in the method embodiments of the present disclosure, and that the above and other operations and/or functions of the individual units of the transmitter 400 are intended to perform the corresponding processes of the transmitter in the method embodiments illustrated in FIGS. 2 to 4. The details are not repeated herein for brevity.

FIG. 6 is a schematic block diagram of a receiver 500 according to some embodiments of the present disclosure. As illustrated in FIG. 6, the receiver 500 includes: a processing unit 510, configured to generate a target sequence initial seed based on target channel information, wherein the target channel information is channel information corresponding to a link between a transmitter and the receiver.

In some embodiments, the processing unit 510 is further configured to: generate a first sequence initial seed based on the target channel information; and determine the first sequence initial seed as the target sequence initial seed.

In some embodiments, the processing unit 510 is further configured to: generate the target sequence initial seed based on the target channel information and a first parameter, wherein the first parameter includes at least one of a time parameter, a configuration parameter, or a predefined parameter.

In some embodiments, the processing unit is further configured to: generate a first sequence initial seed based on the target channel information; and generate the target sequence initial seed based on the first sequence initial seed and the first parameter.

In some embodiments, the processing unit 510 is further configured to: generate the target sequence initial seed by performing an accumulate operation, a modulo operation, or a Fourier transform operation on the first sequence initial seed and the first parameter.

In some embodiments, the time parameter includes at least one of: a symbol occupied by the target sequence initial seed, a slot occupied by the target sequence initial seed, a subframe occupied by the target sequence initial seed, or a frame occupied by the target sequence initial seed.

In some embodiments, the processing unit 510 is further configured to: generate the first sequence initial seed based on feature information in the target channel information.

In some embodiments, the feature information in the target channel information includes at least one of: amplitude information in the target channel information, phase information in the target channel information, or mapping information in the target channel information in a specific domain.

In some embodiments, the specific domain includes an FFT domain.

In some embodiments, the target channel information includes channel information on N frequency domain units, wherein Nis a positive integer.

In some embodiments, the frequency domain unit includes at least one of: a subcarrier, a RB, a sub-band, a BWP, or a carrier.

In some embodiments, the processing unit 510 is further configured to: generate the first sequence initial seed based on amplitude information in the channel information on the N frequency domain units.

In some embodiments, the processing unit 510 is further configured to: acquire N quantized amplitude values by performing a quantization process on the amplitude information in the channel information on the N frequency domain units; and generate the first sequence initial seed based on at least one quantized amplitude value of the N quantized amplitude values.

In some embodiments, the processing unit 510 is further configured to:
acquire the N quantized amplitude values by performing a binary quantization on the amplitude information in the channel information on the N frequency domain units based on a first amplitude threshold; or
acquire the N quantized amplitude values by rounding the amplitude information in the channel information on the N frequency domain units; or
acquire the N quantized amplitude values by performing a modulo process on the amplitude information in the channel information on the N frequency domain units with respect to a second amplitude threshold.

In some embodiments, the processing unit 510 is further configured to: generate the first sequence initial seed according to the following formula:

$$C = {\sum }_{i = 0}^{Q} {A}^{′} ( i ) \cdot {2}^{i}$$

$$or$$

$$C = {A}^{′} ( n )$$

wherein C represents the first sequence initial seed, A′(i) represents an quantized amplitude value of the channel information on an i^{th} frequency domain unit of the N frequency domain units, Q represents the number of the at least one quantized amplitude value minus 1, Q is an integer, and A′(n) represents an quantized amplitude value of the channel information on an n^{th} frequency domain unit of the N frequency domain units, wherein 0≤n≤N−1.

In some embodiments, the processing unit 510 is further configured to: generate the first sequence initial seed based on phase information in the channel information on the N frequency domain units.

In some embodiments, the processing unit 510 is further configured to: acquire N quantized phase values by performing a quantization process on the phase information in the channel information on the N frequency domain units; and generate the first sequence initial seed based on at least one quantized phase value of the N quantized phase values.

In some embodiments, the processing unit 510 is further configured to:
acquire the N quantized phase values by performing a binary quantization on the phase information in the channel information on the N frequency domain units based on a first phase threshold; or
acquire the N quantized phase values by rounding the phase information in the channel information on the N frequency domain units; or
acquire the N quantized phase values by performing a modulo process on the phase information in the channel information on the N frequency domain units with respect to a second phase threshold.

In some embodiments, the processing unit 510 is further configured to: generate the first sequence initial seed according to the following formula:

$$C = {\sum }_{i = 0}^{P} {θ}^{′} ( i ) \cdot {2}^{i}$$

$$or$$

$$C = {θ}^{′} ( n )$$

wherein C represents the first sequence initial seed, θ′(i) represents a quantized phase value of the channel information on an i^{th} frequency domain unit, P represents the number of the at least one quantized phase value minus 1, P is an integer, and θ′(n) represents a quantized phase value of the channel information on an n^{th} frequency domain unit of the N frequency domain units, wherein 0≤n≤N−1.

In some embodiments, the processing unit 510 is further configured to: generate the first sequence initial seed based on the mapping information in the channel information on the N frequency domain units in a Fourier transform domain.

In some embodiments, the processing unit 510 is further configured to:
determine, based on the channel information on each frequency domain unit of the N frequency domain units, a target codebook corresponding to the channel information on each frequency domain unit from a candidate codebook set, wherein index information of the target codebook corresponding to the channel information on each frequency domain unit indicates the mapping information in the channel information on each frequency domain unit in the Fourier transform domain; and
generate the first sequence initial seed based on the index information of the target codebook corresponding to the channel information on at least one frequency domain unit of the N frequency domain units.

In some embodiments, the processing unit 510 is further configured to: generate the first sequence initial seed according to the following formula:

$$C = {\sum }_{l = 0}^{X} {i}_{1} ( l ) \text{?} {15}^{l} + {\sum }_{l = 0}^{X} {i}_{2} ( l ) \cdot {15}^{l}$$

$$\text{?} \text{indicates text missing or illegible when filed}$$

wherein C represents the first sequence initial seed, i₁(l) and i₂(l) represent the index information of the target codebook corresponding to the channel information on an i^{th} frequency domain unit of the N frequency domain units, X represents the number of the at least one frequency domain unit minus 1, and X is an integer.

In some embodiments, in the candidate codebook set, an inner product of the target codebook and the channel information on the frequency domain unit is the largest.

In some embodiments, the receiver 500 further includes: a communication unit, configured to detect a target sequence based on the target sequence initial seed.

In some embodiments, the communication unit is a communication interface, a transceiver, a communication chip, or an input/output interface of system-on-chip; and the processing unit is one or more processors.

It is understandable that the receiver 500 according to the embodiments of the present disclosure corresponds to the receiver in the method embodiments of the present disclosure, and that the above and other operations and/or functions of the individual units of the receiver 500 are intended to perform the corresponding processes of the receiver in the method embodiments illustrated in FIGS. 2 to 4. The details are not repeated herein for brevity.

FIG. 7 is a schematic block diagram of a communication device 600 according to some embodiments of the present disclosure. The communication device 600 illustrated in FIG. 7 includes a processor 610, wherein the processor 610, when loading and running at least one computer program from a memory, is caused to perform the methods in the embodiments of the present disclosure.

In some embodiments, as illustrated in FIG. 7, the communication device 600 includes a memory 620, and the processor 610, when loading and running at least one computer program from the memory 620, is caused to perform the methods in the embodiments of the present disclosure. The memory 620 is an individual device independent of the processor 610, or the memory 620 is integrated in the processor 610.

In some embodiments, as illustrated in FIG. 7, the communication device 600 includes a transceiver 630, and the processor 610 is capable of controlling the transceiver 630 to communicate with other devices. For example, the processor 610 controls the transceiver 630 to transmit information or data to other devices or receive information or data from other devices.

The transceiver 630 may include a transmitter and a receiver, and the transceiver 630 may further include one or more antennas.

In some embodiments, the communication device 600 is the network device in the embodiments of the present disclosure, and the communication device 600 performs the corresponding processes performed by the network device in the methods according to the embodiments of the present disclosure. The details are not repeated herein for brevity.

In some embodiments, the communication device 600 is the transmitter in the embodiments of the present disclosure, and the communication device 600 performs the corresponding processes performed by the transmitter in the methods according to the embodiments of the present disclosure. The details are not repeated herein for brevity.

In some embodiments, the communication device 600 is the receiver in the embodiments of the present disclosure, and the communication device 600 performs the corresponding processes performed by the receiver in the methods according to the embodiments of the present disclosure. The details are not repeated herein for brevity.

In some embodiments, the processor 610 corresponds to the processing unit 410 in the transmitter 400 illustrated in FIG. 5, and the processor 610 is configured to perform the corresponding processes performed by the processing unit 410. The details are not repeated herein for brevity.

In some embodiments, the transceiver 630 corresponds to the communication unit in the transmitter 400 illustrated in FIG. 5, and the transceiver 630 is configured to perform the corresponding processes performed by the communication unit. The details are not repeated herein for brevity.

In some embodiments, the processor 610 corresponds to the processing unit 510 in the receiver 500 illustrated in FIG. 6, and the processor 610 is configured to perform the corresponding processes performed by the processing unit 510. The details are not repeated herein for brevity.

In some embodiments, the transceiver 630 corresponds to the communication unit in the receiver 500 illustrated in FIG. 6, and the transceiver 630 is configured to perform the corresponding processes performed by the communication unit. The details are not repeated herein for brevity.

FIG. 8 is a schematic structural diagram of a chip according to some embodiments of the present disclosure. The chip 700 illustrated in FIG. 8 includes a processor 710, wherein the processor 710, when loading and running at least one program from a memory, is caused to perform the methods in the embodiments of the present disclosure.

In some embodiments, as illustrated in FIG. 8, the chip 700 further includes a memory 720. The processor 710, when loading and running at least one computer program from the memory 720, is caused to perform the methods in the embodiments of the present disclosure.

The memory 720 is an individual device independent of the processor 710, or the memory 720 is integrated in the processor 710.

In some embodiments, the chip 700 includes an input interface 730. The processor 710 is capable of controlling the input interface 730 to communicate with other devices or chips. For example, the processor 710 controls the input interface 730 to acquire information or data from other devices or chips.

In some embodiments, the chip 700 includes an output interface 740. The processor 710 is capable of controlling the output interface 740 to communicate with other devices or chips. For example, the processor 710 controls the output interface 740 to output information or data to other devices or chips.

In some embodiments, the chip is applicable to the network device in the embodiments of the present disclosure, and the chip performs the corresponding processes performed by the network device in the methods in the embodiments of the present disclosure. The details are not repeated herein for brevity.

In some embodiments, the chip is applicable to the transmitter in the embodiments of the present disclosure, and the chip performs the corresponding processes performed by the transmitter in the methods in the embodiments of the present disclosure. The details are not repeated herein for brevity.

In some embodiments, the chip is applicable to the receiver in the embodiments of the present disclosure, and the chip performs the corresponding processes performed by the receiver in the methods in the embodiments of the present disclosure. The details are not repeated herein for brevity.

In some embodiments, the processor 710 corresponds to the processing unit 410 in the transmitter 400 illustrated in FIG. 5, and the processor 710 is configured to perform the corresponding processes performed by the processing unit 410. The details are not repeated herein for brevity.

In some embodiments, the output interface 740 corresponds to the communication unit in the transmitter 400 illustrated in FIG. 5, and the output interface 740 is configured to perform the corresponding processes performed by the communication unit. The details are not repeated herein for brevity.

In some embodiments, the processor 710 corresponds to the processing unit 510 in the receiver 500 illustrated in FIG. 6, and the processor 710 is configured to perform the corresponding processes performed by the processing unit 510. The details are not repeated herein for brevity.

In some embodiments, the input interface 730 corresponds to the communication unit in the receiver 500 illustrated in FIG. 6, and the input interface 730 is configured to perform the corresponding processes performed by the communication unit. The details are not repeated herein for brevity. It is understandable that the chip mentioned in the embodiments of the present disclosure may also be referred to as a system-level chip, a system chip, a chip system, a system-on-chip, or the like.

FIG. 9 is a schematic block diagram of a communication system 900 according to some embodiments of the present disclosure. As illustrated in FIG. 9, the communication system 900 includes a transmitter 910 and a receiver 920.

The transmitter 910 is configured to achieve the corresponding functions achieved by the transmitter in the methods described above, and the receiver 920 is configured to achieve the corresponding functions achieved by the receiver in the methods described above. The details are not repeated herein for brevity.

It is understandable that the processor in the embodiments of the present disclosure is an integrated circuit chip with a signal processing capability. In the implementations, the processes in the method embodiments are achieved by integrated logic circuits of hardware in the processor or instructions in the software form. The above processor is a general processor, a digital signal processor (DSP), an application-specific integrated circuit (ASIC), a field-programmable gate array (FPGA), other programmable logic devices, discrete gates, transistor logic devices, or discrete hardware assemblies that can achieve or perform various methods, processes, and logic blocks according to the embodiments of the present disclosure. The general processor is a microprocessor, any conventional processor, or the like. The processes in conjunction with the method in the embodiments of the present disclosure can be directly embodied as a hardware decoding processor for processing or be performed by a combination of hardware and software modules in the decoding processor. The software modules are disposed in a random access memory, a flash memory, a read-only memory, a programmable read-only memory, an electrically erasable programmable memory, a register, and other storage mediums mature in the field. The storage medium is disposed in the memory, and the processor reads the information in the memory and combines with its hardware to perform the processes of the above methods.

It is understandable that the memory in embodiments of the present disclosure is a volatile memory or a non-volatile memory, or includes both the volatile memory and the non-volatile memory. The non-volatile memory is a read-only memory (ROM), a programmable ROM (PROM), an erasable PROM (EPROM), an electrically EPROM (EEPROM), or a flash memory. The volatile memory is a random access memory (RAM) used as an external cache. By way of example but not limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the system and the memory described herein are intended to include, but not limit to these and any other suitable type of memories.

It is understandable that the above memory is exemplary but not for limitation. For example, the memory in the embodiments of the present disclosure is also an SRAM, a DRAM, an SDRAM, a DDR SDRAM, an ESDRAM, an SLDRAM, a DR RAM, or the like. That is, the memory in the embodiments of the present disclosure is intend to include, but not limit to these and any other suitable type of memory.

Embodiments of the present disclosure further provide a non-transitory computer-readable storage medium for storing one or more computer programs.

In some embodiments, the non-transitory computer-readable storage medium is applicable to the network device in the embodiments of the present disclosure, and the one or more computer programs, when loaded and run by a computer, cause the computer to perform the corresponding processes performed by the network device in the methods according to the embodiments of the present disclosure, which are not described herein for brevity.

In some embodiments, the non-transitory computer-readable storage medium is applicable to the transmitter or receiver in the embodiments of the present disclosure, and the one or more computer programs, when loaded and run by a computer, cause the computer to perform the corresponding processes performed by the transmitter or receiver in the methods according to the embodiments of the present disclosure, which are not described herein for brevity.

Embodiments of the present disclosure further provide a computer program product. The computer program product includes one or more computer program instructions.

In some embodiments, the computer program product is applicable to the network device in the embodiments of the present disclosure, and the one or more computer program instructions, when loaded and executed by a computer, cause the computer to perform the corresponding processes performed by the network device in the methods according to the embodiments of the present disclosure, which are not described herein for brevity.

In some embodiments, the computer program product is applicable to the transmitter or receiver in the embodiments of the present disclosure, and the one or more computer program instructions, when loaded and executed by a computer, cause the computer to perform the corresponding processes performed by the transmitter or receiver in the methods according to the embodiments of the present disclosure, which are not described herein for brevity.

Embodiments of the present disclosure further provide a computer program.

In some embodiments, the computer program is applicable to the network device in the embodiments of the present disclosure, and the computer program, when loaded and run by a computer, causes the computer to perform the corresponding processes performed by the network device in the methods according to the embodiment of the present disclosure, which are not described herein for brevity.

In some embodiments, the computer program is applicable to the transmitter or receiver in the embodiments of the present disclosure, and the computer program, when loaded and run by a computer, causes the computer to perform the corresponding processes performed by the transmitter or receiver in the methods according to the embodiments of the present disclosure, which are not described herein for brevity.

It can be understood by those of ordinary skill in the art that the units and algorithmic processes of the examples described in conjunction with the embodiments disclosed herein can be achieved by the electronic hardware, or by a combination of the computer software and the electronic hardware. Whether these functions are implemented by the hardware or the software depends on the specific application and design constraints of the technical solution. With respect to each application, those skilled in the art may use different methods to achieve the described functions, and such implementations should not be considered beyond the scope of the present disclosure.

It can be understood by those skilled in the art that with respect to the specific operation processes of the system, device, and unit described above, reference is made to the corresponding processes in the above method embodiments for convenience and simplicity of description, which are not repeated herein.

In the embodiments of the present disclosure, it is understandable that the systems, devices, and methods can be implemented in other ways. For example, the above apparatus embodiments are only exemplary. For example, the division of the units is only the logical function division, and the actual implementation may have another division. For example, several units or assemblies can be combined or integrated into another system, or some features can be ignored or not performed. In addition, the coupling, the direct coupling, or the communication connection between each other may be achieved by some interfaces, and the indirect coupling or communication connection between devices or units may be electrical, mechanical or in other form.

The units described as separate parts may or may not be physically separate, and the parts illustrated as the units may or may not be physical units. That is, the parts may be disposed in one place, or distributed in several network units. Some or all of the units can be selected based on actual needs to achieve the purpose of the technical solutions according to the embodiments.

In addition, the functional units in the embodiments of the present disclosure may be integrated in a processing unit or exist physically separately, or two or more units may be integrated in a unit.

In the case that the functions are achieved in the form of software functional units and sold or used as stand-alone products, the functions may be stored in a non-transitory computer-readable storage medium. Based on this understanding, the nature of the technical solutions of the present disclosure, the part contributed to the prior art, or the part of the technical solutions may be embodied in the form of a software product, wherein the software product is stored in a storage medium and includes a number of instructions for causing a computer device (which may be a personal computer, a server, a network equipment, or the like) to perform all or part of the processes of the method in various embodiments of the present disclosure. The above storage medium includes: a U disk, a mobile hard disk, a ROM, a RAM, a disk, a disc, or other medium that can store program codes.

Described above are merely embodiments of the present disclosure, and the protection scope of the present disclosure is not limited. Any changes or replacements made within the technical scope of the present disclosure by those skilled in the art should be encompassed within the protection scope of the present disclosure. Thus, the protection scope of the present disclosure shall prevail in the protection scope of the claims.

1. A method for generating a sequence, applicable to a transmitter, the method comprising:
generating a target sequence initial seed based on target channel information, wherein the target channel information is channel information corresponding to a link between the transmitter and a receiver.

2. The method according to claim 1, wherein generating the target sequence initial seed based on the target channel information comprises:
generating a first sequence initial seed based on the target channel information; and
determining the first sequence initial seed as the target sequence initial seed.

3. The method according to claim 1, wherein generating the target sequence initial seed based on the target channel information comprises:
generating the target sequence initial seed based on the target channel information and a first parameter, wherein the first parameter comprises at least one of a time parameter, a configuration parameter, or a predefined parameter.

4. The method according to claim 3, wherein generating the target sequence initial seed based on the target channel information and the first parameter comprises:
generating a first sequence initial seed based on the target channel information; and
generating the target sequence initial seed based on the first sequence initial seed and the first parameter.

5. The method according to claim 2, wherein generating the first sequence initial seed based on the target channel information comprises:
generating the first sequence initial seed based on feature information in the target channel information.

6. The method according to claim 5, wherein the feature information in the target channel information comprises at least one of: amplitude information in the target channel information, phase information in the target channel information, or mapping information in the target channel information in a specific domain.

7. The method according to claim 5, wherein the target channel information comprises channel information on N frequency domain units, wherein N is a positive integer.

8. The method according to claim 7, wherein generating the first sequence initial seed based on the target channel information comprises:
generating the first sequence initial seed based on amplitude information in the channel information on the N frequency domain units.

9. The method according to claim 7, wherein generating the first sequence initial seed based on the target channel information comprises:
generating the first sequence initial seed based on phase information in the channel information on the N frequency domain units.

10. The method according to claim 7, wherein generating the first sequence initial seed based on the target channel information comprises:
generating the first sequence initial seed based on mapping information in the channel information on the N frequency domain units in a Fourier transform domain.

11. A communication device, comprising:
a processor and a memory;
wherein the memory is configured to store one or more computer programs, which when executed by the processor, causes the communication device to:
generate a target sequence initial seed based on target channel information, wherein the target channel information is channel information corresponding to a link between a transmitter and a receiver.

12. The communication device according to claim 11, wherein the one or more computer programs, which when executed by the processor, further causes the communication device to:
generate a first sequence initial seed based on the target channel information; and
determine the first sequence initial seed as the target sequence initial seed.

13. The communication device according to claim 12, wherein the one or more computer programs, which when executed by the processor, further causes the communication device to:
generate the first sequence initial seed based on feature information in the target channel information.

14. The communication device according to claim 13, wherein the target channel information comprises channel information on N frequency domain units, wherein N is a positive integer.

15. The communication device according to claim 13, wherein the one or more computer programs, which when executed by the processor, further causes the communication device to:
generate the first sequence initial seed based on mapping information in the channel information on the N frequency domain units in a Fourier transform domain.

16. The communication device according to claim 11, wherein the one or more computer programs, which when executed by the processor, further causes the communication device to:
generate a target sequence based on the target sequence initial seed; and
transmit the target sequence to the receiver.

17. A communication device, comprising:
a processor and a memory;
wherein the memory is configured to store one or more computer programs, which when executed by the processor, causes the communication device to:
generate a target sequence initial seed based on target channel information, wherein the target channel information is channel information corresponding to a link between a transmitter and a receiver.

18. The communication device according to claim 17, wherein the one or more computer programs, which when executed by the processor, further causes the communication device to:
generate a first sequence initial seed based on the target channel information; and
determine the first sequence initial seed as the target sequence initial seed.

19. The communication device according to claim 18, wherein the one or more computer programs, which when executed by the processor, further causes the communication device to:
generate the target sequence initial seed based on the target channel information and a first parameter, wherein the first parameter comprises at least one of a time parameter, a configuration parameter, or a predefined parameter.

20. The communication device according to claim 19, wherein the one or more computer programs, which when executed by the processor, further causes the communication device to:
generate a first sequence initial seed based on the target channel information; and
generate the target sequence initial seed based on the first sequence initial seed and the first parameter.
